(19) United States
(12) Patent Application Publication
(10) Pub. No.: US 2026/0072407 A1
(43) Pub. Date: Mar. 12, 2026

(54) WATCH CASE FOR A WRISTWATCH WITH A MUSICAL OR RINGING MECHANISM HAVING A BOTTOM WITH A COVER

(71) Applicant: Manufacture d'Horlogerie Audemars Piguet SA, Le Brassus (CH)

(72) Inventor: Michaël HUGUENIN-VIRCHAUX, Le Locle (CH)

(73) Assignee: Manufacture d'Horlogerie Audemars Piguet SA, Le Brassus (CH)

(21) Appl. No.: 19/107,482

(22) PCT Filed: Sep. 1, 2023
(86) PCT No.: PCT/IB2023/058649

§ 371 Date: Feb. 27, 2025

(30) Foreign Application Priority Data
Sep. 2, 2022 (EP) 22193716.2

(51) Int. Cl. G04B 37/00; G04B 21/00; G04B 23/00

(52) U.S. Cl. CPC G04B 37/0016; G04B 21/00; G04B 23/00

(57) ABSTRACT

A watch case for a wristwatch with a musical or ringing mechanism, the case being configured to comprise an acoustic membrane held by its periphery at a bottom of the watch case The watch case comprises a cover comprising a bottom. The cover is articulated mounted between an open position and a closed position in which the bottom of the cover covers an outer face of the acoustic membrane so as to ensure that the membrane can vibrate freely. The watch case further comprises at least one sound diffusion opening

### TECHNICAL FIELD

The present invention relates to a watch case for a wristwatch, comprising a case back with a cover. The watch case is designed to house an acoustic membrane as well as a movement that includes a musical or ringing mechanism. The present invention also relates to a wristwatch with musical or ringing mechanism, comprising the watch case with the case back with a cover.

### BACKGROUND ART

The use of covers was originally to protect the glasses of pocket watches, but they also provided surfaces for engraving or guilloche. When the watch transitioned from the pocket to the wrist, watchmaking naturally lost the use of covers. However, various watch brands offer wristwatches featuring a hinged cover on the back of the watch case, in order to revive this tradition. Pressing the crown allows the cover, which hides the transparent case back, to open, thus revealing the movement. An engraving or another ornamental design can also be present on the hidden side of the cover. As a result, the ornamental design is only visible when the cover is opened.

The user can thus wear a wristwatch in a discreet and elegant style, containing an exceptional mechanical movement whose artisanal finishes, requiring a high level of craftsmanship, can be admired when the wristwatch is removed from the wrist and the opening of the watch case cover is actuated by a simple press of the crown.

Wristwatches with musical or ringing mechanisms are also known, where the movement includes, for example, a minute repeater or a grande sonnerie mechanism.

For example, EP3009895 discloses a musical or ringing wristwatch equipped with an acoustic radiation arrangement. The wristwatch includes a watch case comprising a middle case, a case back fixed to the middle case, and a glass to close the case on the dial side. The acoustic radiation arrangement includes a support and connection piece fixed within the case back, between a case back bezel and a case back glass, as well as an annular cavity defined around the entire perimeter of the support piece and facing an inner surface of the case back bezel. The case back bezel comprises several side openings. Membranes with small holes cover the side openings to allow the passage of air while preventing dirt from entering the annular cavity.

By covering the side openings with membranes featuring small holes, it is possible to allow sound to escape from the watch case while preventing the back glass from getting dirty over time due to the accumulation of dust particles entering through the openings. However, although this small-holed membrane can be effective at trapping dust or other impurities, it eventually becomes clogged over time, muffling or reducing the diffusion of sound from the watch case. Furthermore, once clogged, the membrane becomes difficult to clean.

EP3812845 discloses a timepiece equipped with a vibration-generating device designed to produce sound, and comprising a chamber. This chamber is bounded by a membrane and a glass through which the time display using hands is visible. The chamber includes at least one opening directed towards the exterior of the piece. This opening is protected by a filter that is permeable to air but impermeable to water, in order to prevent impurities from entering the chamber. However, this filter also faces the problem of clogging due to the accumulation of impurities.

CN111596539 discloses a ringing timepiece comprising a protective cover hinged to the case so that it can fold against a glass on the dial side. This glass comprises a sound transmission opening, while the cover includes a sealing element designed to close the sound transmission opening when the protective cover is folded against the glass. Therefore, the sound is transmitted outside the watch case only when the protective cover is pivoted, allowing the user to view the ringing mechanism.

DE9415102U1 also discloses a travel or pocket alarm clock comprising a hinged cover on the back side. This cover is attached to the case by a snap connection so that it can serve as a stand for the alarm clock.

An aim of the present invention is to propose a watch case for a wristwatch with a musical or ringing mechanism, providing an alternative solution to the problems related to dust and dirt, and in particular a solution that resolves at least partially the aforementioned issues.

Another aim of the present invention is to propose a watch case for a wristwatch with a musical or ringing mechanism, configured to sustainably promote the propagation of sound vibrations outside the watch case.

### BRIEF SUMMARY OF THE INVENTION

These aims are achieved, in particular, by a watch case for a wristwatch with a musical or ringing mechanism, configured to comprise an acoustic membrane held by its periphery at the bottom of the watch case. The watch case comprises a cover comprising a bottom. The cover is articulated mounted between an open position and a closed position in which the bottom of the cover covers an outer face of the acoustic membrane so as to ensure that the membrane can vibrate freely. The watch case further comprises at least one sound diffusion opening.

According to one embodiment, the watch case includes multiple openings distributed around the acoustic membrane.

According to one embodiment, the combined width of all the openings represents at least 50%, preferably at least 80%, or even at least 95% of the perimeter of the acoustic membrane.

According to one embodiment, the acoustic membrane is held in place by a bottom edge covering the periphery of the acoustic membrane, more specifically the periphery of the outer face of the acoustic membrane.

According to one embodiment, the watch case further includes a seal positioned between the bottom edge of the watch case and the acoustic membrane to ensure the sealing of the bottom side of the watch case.

According to one embodiment, said at least one opening consists of one or more holes with a circular or oblong shape, preferably in the form of a slot.

According to one embodiment, said at least one opening consists of one or more interstices located between the bottom edge and the cover in the closed position.

According to one embodiment, said at least one opening consists of one or more radial grooves formed on the surface of the bottom edge.

According to one embodiment, the cover further comprises an edge surrounding the bottom and a bottom support configured so that the bottom of the cover is spaced from a general plane defined by the edge surrounding the bottom. Said at least one opening is located between the bottom and the edge of the cover.

According to one embodiment, at least one of the bottom of the cover and the acoustic membrane is opaque, at least partially transparent, or at least partially translucent.

According to one embodiment, the watch case further comprises a locking mechanism for securing the cover in the closed position.

According to one embodiment, the locking mechanism comprises a slider that can be operated to open the cover.

According to one embodiment, the cover is hinged-mounted on the bottom edge.

According to one embodiment, the cover is mounted articulated via an articulation in the form of a pivot-joint, a ball-and-socket joint, or a slider.

Another aspect of the invention relates to a wristwatch comprising the aforementioned watch case.

### BRIEF SUMMARY OF THE FIGURES

Examples of embodiments of the invention are provided in the description illustrated by the attached figures, in which:

FIG. 1 illustrates a perspective view of a watch case for a wristwatch with musical or ringing mechanism, comprising a transparent-bottom cover in an open position, according to a preferred embodiment,

FIG. 2 illustrates a perspective view of the watch case from FIG. 1, shown from a different orientation.

### EXAMPLES OF EMBODIMENTS OF THE INVENTION

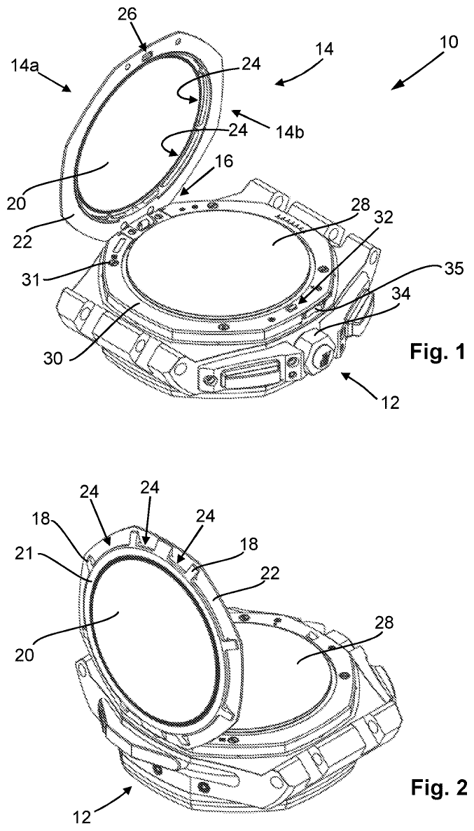

According to a preferred embodiment illustrated in FIGS. 1 and 2, the wristwatch with musical or ringing mechanism comprises a watch case 10 inside of which a watch movement (not shown) is intended to be mounted. This watch movement includes a musical or ringing mechanism, such as a grande sonnerie or minute repeater movement.

The watch case 10 comprises a middle case 12 and, on the bottom side, an acoustic membrane 28, which is preferably transparent to allow viewing of the movement, particularly the hammers and the gong of the musical or ringing mechanism. The acoustic membrane is preferably in the form of a disk, with its periphery typically held between a bottom edge 30 and the middle case 12 of the watch case. The bottom edge 30 is fixed to the middle case 12, preferably by means of several screws 31 that pass through the acoustic membrane from one side to the other.

Preferably, a seal (not visible in the figures) is positioned between the bottom edge 30 and the periphery of the acoustic membrane 28 so that the assembly comprising the acoustic membrane 28, the bottom edge 30, and the seal ensures the sealing of the watch case on the bottom side. The external surface of the membrane 28, as well as the external surface of the bottom edge 30 surrounding the membrane, are preferably coplanar. According to another embodiment, the external surface of the membrane 28 could be positioned in a plane closer to the movement, namely the musical or ringing mechanism, than the external surface of the bottom edge 30.

The acoustic membrane 28 must be able to vibrate freely to ensure proper sound transmission between the interior and exterior of the watch case 10. To provide a good dynamic response, the acoustic membrane is preferably flat and made of a lightweight, rigid material, such as in the form of a sapphire, mineral glass, or plexiglass plate. In cases where the acoustic membrane does not need to be transparent, it can be made from another material, such as metallic glass, titanium, steel, or a copper-based material.

To vibrate freely, the acoustic membrane 28 of such a wristwatch must be isolated from the wearer's wrist. For this purpose, the watch case 10 comprises a cover 14 designed to isolate the membrane 28 from the wrist. In a preferred embodiment, the cover 14 comprises one or more sound diffusion openings 24 arranged around the acoustic membrane to facilitate the diffusion of sound, propagated by the vibration of the membrane, outside the watch case 10. The cover 14 further comprises a bottom 20, for example of circular shape, and an edge 22 surrounding the bottom 20 of the cover. The bottom 20 is preferably flat.

The edge 22 of the cover 14 is preferably pivotally connected to the watch case, for example by means of a hinge 16 fixed to the base edge 30, allowing the cover 14 to occupy a closed position and an open position. In an alternative embodiment, the cover may be mounted pivotally on the middle case 12 of the watch case. Other articulation mechanisms may be considered instead of the hinge, such as a ball joint, a sliding joint, or even another pivot joint with a rotation axis orthogonal to the general plane of the acoustic membrane, enabling the cover 14 to pivot in a plane parallel to that of the acoustic membrane.

The cover 14 further includes a bottom support 18 mounted on the external side 14a of the cover 14 and configured so that the bottom 20 of the cover 14 is positioned at a distance from the general plane defined by the edge 22. In the closed position, the edge 22 of the cover 14 is preferably in contact with the bottom edge 30 of the watch case. Since the bottom 20 of the cover 14 is offset from the edge 22, which is located at the level of the acoustic membrane 28, a space on the order of several tenths of a millimetre can thus be created between the bottom 20 and the acoustic membrane 28. This ensures that the membrane is protected and can vibrate freely under the action of the musical or ringing mechanism.

The bottom support can, for example, act as a spacer and include several legs 18 that separate the edge 22 from the bottom 20. As illustrated in FIG. 2, these legs 18 are integral with the edge 22 and with a circular portion 21 of the bottom 20 of the cover. In the closed position, the cover preferably has a convex shape such that the distance separating the plane of the membrane 28 from the plane of the bottom 20 is greater than the distance separating the plane of the membrane 28 from the plane in which the edge 22 is located. Sound diffusion openings in the form of slits 24 are thus created within the thickness of the cover, particularly between the legs.

The number and position of the legs can vary depending on the chosen design to define the number of slits and their respective lengths around the perimeter of the bottom 20. The various slits could be dimensioned to extend along circular arcs around the bottom 20 and, consequently, around the acoustic membrane 28 when the cover 14 is in the closed position. Together, these slits or openings could cover or extend over at least 200°, preferably at least 300°, or even at least 340° of the circumference of the bottom 20 or the acoustic membrane. At least one of these slits 24 may extend over at least 30°, or even 60° or 90°, of the circumference of the bottom of the cover.

More generally, particularly if the bottom 20 or the elastic membrane 28 are not circular in shape, it can be noted that the total width of the openings 24 represents at least 50%, preferably at least 80%, or even at least 95% of the perimeter of the acoustic membrane 28 or that of the bottom 20.

In another, non-illustrated embodiment, the openings are circular in shape and are preferably distributed around the perimeter or circumference of the bottom 20 or the acoustic membrane 28, preferably in a regular manner.

In another non-illustrated embodiment, one or more sound openings are formed at the interface between the edge 22 of the cover 14 and the bottom edge 30 of the watch case when the cover is in the closed position. In this case, the cover 14 does not have any sound diffusion openings. Instead, the surface of the bottom edge 30, which is intended to come into contact with the edge 22 of the cover 14 when it is brought into the closed position, may include at least one radial groove extending radially from an inner edge to an outer edge of the bottom edge 30 and acting as an opening 24 for the diffusion of sound out of the watch case.

In another non-illustrated example, at least one opening could be created by a gap located between the bottom edge 30 and the cover 14 when the latter is in the closed position. To achieve this, a plurality of protrusions or other projections could serve as spacers, preventing the edge 22 of the cover from directly contacting the bottom edge 30. These projections could be integral with the edge 22 and/or the bottom edge 30.

Alternatively or additionally, a locking mechanism for the cover could hold the edge 22 of the cover away from the bottom edge 30, creating at least one gap between these two parts that serves as an opening 24 when the cover is, in the closed position, locked to the middle case 12 or another part of the watch case.

In another example, the edge 22 of the cover 14 is mounted pivotally, for instance by rotation, on the bottom edge 30 or on the middle case 12 of the watch case.

In an unillustrated variant, the bottom support 18 could take the form of a ring with at least one radial sound diffusion opening 24. In one embodiment, the bottom support 18, the edge 22, and the circular portion 21 of the bottom 20 are made as a single piece, for example by moulding or galvanic growth.

In the open position of the cover 14, the external surface (or outer face) of the acoustic membrane 28, the bottom 20 on the inner side 14b of the cover, and, if applicable, the openings 24 formed in the bottom support 18 or on the surface of the bottom edge 30 are advantageously directly accessible to the user. This allows the user to regularly and easily clean not only these openings 24 but also the inside of the bottom 20 of the cover and the external surface of the acoustic membrane 28 to prevent the accumulation of dirt particles that could obstruct the visual appearance of the movement's back as seen through the back of the cover and the membrane. Moreover, cleaning the acoustic membrane helps prevent it from becoming clogged over time with deposited particles, which could hinder the optimal vibration of the membrane and affect the sound quality of the sound diffused out of the watch case through one or more sound openings.

In one embodiment, the cover 14 can be held in the closed position by a locking mechanism. According to the example illustrated in FIG. 1, the locking mechanism comprises a male element 32 and a slot 26. The male element 32 is located on the bottom edge 30, for example at the position of the crown 34 (i.e., at 3 o'clock). This male element 32 is intended to cooperate with the slot 26 located opposite it on the edge 22 of the cover, particularly on its inner side 14b. This cooperation allows the cover 14 to be locked to the middle case 12, particularly to the bottom edge 30 integral with the middle case.

In this example, the slot 26 is diametrically opposite to the hinge 16 of the cover 14. The opening of the cover 14 can, for example, be done via a sliding mechanism 35 located at the position of the crown 34. Alternatively, the opening of the cover could be achieved by positioning the crown in a predetermined axial position.

In a preferred embodiment, the bottom 20 of the cover 14 and the acoustic membrane 28 are transparent or partially transparent, allowing the movement to be visible from the bottom without the need to open the cover. The bottom is, for example, made of sapphire glass. Alternatively, at least one of the bottom 20 and the acoustic membrane could be at least partially translucent or opaque. In addition or as an alternative to these embodiments, at least one of the bottom 20 and the acoustic membrane 28 could include an ornament or engraving, for example.

The bottom of the cover of the watch case can have other visual appearances depending on different design variants. For example, the bottom could be a transparent glass with decals, markings made preferably by laser, or any other pattern created by various methods. The use of a frosted glass for the bottom, with or without transparent areas in places, a glass with a gradient from opaque to transparent, or even a smoked glass, could also be considered.

### LIST OF REFERENCES

Watch case 10
Middle case 12
Cover 14
External side 14a
Inner side 14b
Articulation 16 (e.g. hinge)
Bottom support 18
Bottom 20
Circular portion 21
Edge 22
Opening 24
Slot 26
Transparent membrane 28
Bottom edge 30
Screw 31
Male element 32
Crown 34
Sliding mechanism 35

1. Watch case for a wristwatch with a musical or ringing mechanism, configured to comprise an acoustic membrane held by its periphery at a bottom of the watch case, said case comprising a cover with a bottom, the cover being articulated mounted between an open position and a closed position, wherein the bottom of the cover covers an outer face of the acoustic membrane so as to ensure that said membrane can vibrate freely, the watch case further comprising at least one sound diffusion opening.

2. Watch case of claim 1, comprising multiple openings distributed around the acoustic membrane.

3. Watch case of claim 1, wherein the combined width of all the openings represents at least 50%, preferably at least 80%, or even at least 95% of the perimeter of the acoustic membrane.

4. Watch case of claim 1, wherein the acoustic membrane is held in place by a bottom edge covering the periphery of the acoustic membrane.

5. Watch case of claim 4, further comprising a seal positioned between the bottom edge of the watch case and the acoustic membrane to ensure the sealing of the bottom side of the watch case.

6. Watch case of claim 1, wherein said at least one opening consists of one or more holes with a circular or oblong shape, preferably in the form of a slot.

7. Watch case of claim 4, said at least one opening consists of one or more interstices located between the bottom edge and the cover in the closed position.

8. Watch case of claim 4, wherein said at least one opening consists of one or more radial grooves formed on the surface of the bottom edge.

9. Watch case of claim 1, wherein the cover further comprises an edge surrounding the bottom and a bottom support configured so that the bottom of the cover is spaced from a general plane defined by the edge surrounding the bottom, said at least one opening being located between the bottom and the edge of the cover.

10. Watch case of claim 1, wherein at least one of the bottom of the cover and the acoustic membrane is opaque, at least partially transparent, or at least partially translucent.

11. Watch case of claim 1, further comprising a locking mechanism for securing the cover in said closed position.

12. Watch case of claim 11, wherein the locking mechanism comprises a slider that can be operated to open the cover.

13. Watch case of claim 4, wherein the cover is hinge-mounted on the bottom edge.

14. Watch case of claim 1, wherein the cover is mounted articulated via an articulation in the form of a pivot-joint, a ball-and-socket joint, or a slider.

15. Wristwatch comprising the watch case of claim 1.
